(19) United States
(12) Patent Application Publication
(10) Pub. No.: US 2013/0294331 A1
(43) Pub. Date: Nov. 7, 2013

(54) Method for Distributed Relay Discovery and Data Forwarding

(71) Applicant: MEDIATEK Singapore Pte. Ltd., (US)

(72) Inventors: Chao-Chun Wang, Taipei City (TW); Chi-Shi Yee, Hsinchu County (TW)

(73) Assignee: MEDIATEK Singapore Pte. Ltd., Singapore (SG)

(21) Appl. No.: 13/875,488

(22) Filed: May 2, 2013

Related U.S. Application Data
(60) Provisional application No. 61/642,199, filed on May 3, 2012.

(51) Int. Cl. H04B 7/155

(52) U.S. Cl. CPC H04B 7/155
USPC 370/315

(57) ABSTRACT

A method of discovering relay agent in a wireless communications system is provided. A wireless station first sends a relay solicitation frame to query availability of relay agent. The wireless station then receives one or more relay acknowledgement frames from one or more candidate relay agents in response to the relay solicitation frames. The wireless station determines a selected relay agent, and establishes a wireless link with the selected relay agent. The selected relay agent performs data forwarding between the station and an access point. The method allows a wireless station to initiate the relay agent discovery process by soliciting a specific relay agent or broadcasting a request to all potential relay agents. The selected relay agent can be determined with minimum power and based on link quality associated with the relay agent and specific requirement of the wireless station.

### CROSS REFERENCE TO RELATED APPLICATIONS

This application claims priority under 35 U.S.C. §119 from U.S. Provisional Application No. 61/642,199, entitled “A method for distributed relay discovery and data forwarding,” filed on May 3, 2012, the subject matter of which is incorporated herein by reference.

### TECHNICAL FIELD

The disclosed embodiments relate generally to wireless network communications, and, more particularly, to distributed relay discovery in wireless communications systems.

### BACKGROUND

In a wireless communications network, a relay agent for wireless communications stations can extend the range of the wireless communications network and facilitate the power saving operation for the wireless communications stations. For wireless stations with limited range extension, a relay agent can extend the range of its transmission by relaying the data transmitted by the wireless stations. For many battery-operated wireless stations, it is desirable to conserve power and those stations can achieve power saving by transmitting at a lower power via a nearby relay agent.

Conventionally, relay agents in a wireless communications network are pre-configured by the administrator of the network. The orderly setup and configuration of relay agents is the standard practice for managing wireless communications networks. However, the conventional configuration of relay agents may not achieve the best result for a wireless communications network. Wireless stations are not necessarily distributed uniformly in the coverage of the wireless communications network. The loading of relay agents differs and it is hard to redistribute loading under the conventional configuration. Moreover, the conventional configuration is static and cannot accommodate the mobility requirements of the wireless communications network. For example, wireless stations are moving within a wireless communications network. The wireless stations are either moving around or entering and leaving the wireless communications network. The association of a wireless station and a relay agent is no longer permanent.

Therefore, the conventional centralized scheme to configure and setup relay agents lack the support to yield optimal configuration of the relay agents in wireless communications networks. On the other hand, in a cooperative wireless communications network, a wireless device may be capable and willing to relay traffic for another wireless device. It is thus desirable to have a protocol to allow wireless stations to initiate relay agent discovery process, and to allow wireless devices capable of relaying traffic for other stations to become distributed opportunistic relay agents.

### SUMMARY

A method of discovering relay agent in a wireless communications system is provided. A wireless station first sends a relay solicitation frame to query availability of relay agent. The wireless station then receives one or more relay acknowledgement frames from one or more candidate relay agents in response to the relay solicitation frames. The wireless station determines a selected relay agent, and establishes a wireless link with the selected relay agent. The selected relay agent performs data forwarding between the station and an access point. The method allows a wireless station to initiate the relay agent discovery process by soliciting a specific relay agent or broadcasting a request to all potential relay agents. The selected relay agent can be determined with minimum power and based on link quality associated with the relay agent and specific requirement of the wireless station.

In one example, the relay solicitation frame is broadcasted to all candidate relay agents in the wireless system (e.g., active scanning). In another example, the relay solicitation frame is unicasted to a specific relay agent in response to a relay announcement frame from the specific relay agent (e.g., passive scanning). In another example, the relay solicitation frame is transmitted according to a specific transmit power or a specific modulation and coding scheme. By gradually increasing the transmit power, the wireless station can find the closest relay agent with minimum power consumption. In yet another example, the relay solicitation frame contains additional link requirement information.

In the opportunistic relay agent discovery, it is up to a relay agent to decide whether it would like to be the relay agent for another wireless station in accordance with a pre-determined rule. In one example, the relay agent first transmits an announcement frame such as a Beacon frame to announce an intent to become the relay agent before receiving the relay solicitation frames. In another example, the relay agent determines whether to respond to the relay solicitation frames based on loading of the relay agent and channel characteristics between the stations and the relay agent. In yet another example, the relay acknowledgment frames comprise additional link quality information corresponds to the relay agent to facilitate the selection of relay agent.

The selected relay agent may also be determined and designated by an access point. The AP first receives relay solicitation frame from wireless stations and corresponding relay announcement frames from candidate relay agents. The AP decides a designated relay agent accordingly for each soliciting station. The AP broadcasts a Relay Designation frame (RDF) to all wireless devices in the network. All the wireless stations and candidate relay agents in the network learn about the designated relay of each soliciting station via the RDF. For example, a soliciting station learns the AID and/or the MAC address of its designated relay agent via the RDF.

Other embodiments and advantages are described in the detailed description below. This summary does not purport to define the invention. The invention is defined by the claims.

### BRIEF DESCRIPTION OF THE DRAWINGS

FIG. 1 illustrates a wireless communications system with opportunistic relay agents in accordance with a novel aspect.

FIG. 2 is a simplified block diagram of a wireless station and a wireless relay agent in accordance with a novel aspect.

FIG. 3 is a diagram of a method of relay agent discovery with active scanning.

FIG. 4 is a diagram of a method of relay agent discovery with passive scanning.

FIG. 5 illustrates one embodiment of designating relay agent via an access point.

FIG. 6 illustrates one embodiment of determining relay agent from wireless station perspective.

FIG. 7 illustrates one embodiment of determining relay agent from relay agent perspective.

FIG. 8 is flow chart of a method of discovering relay agent from wireless station perspective in accordance with a novel aspect.

FIG. 9 is a flow chart of a method of discovering relay agent from relay agent perspective in accordance with a novel aspect.

### DETAILED DESCRIPTION

Reference will now be made in detail to some embodiments of the invention, examples of which are illustrated in the accompanying drawings.

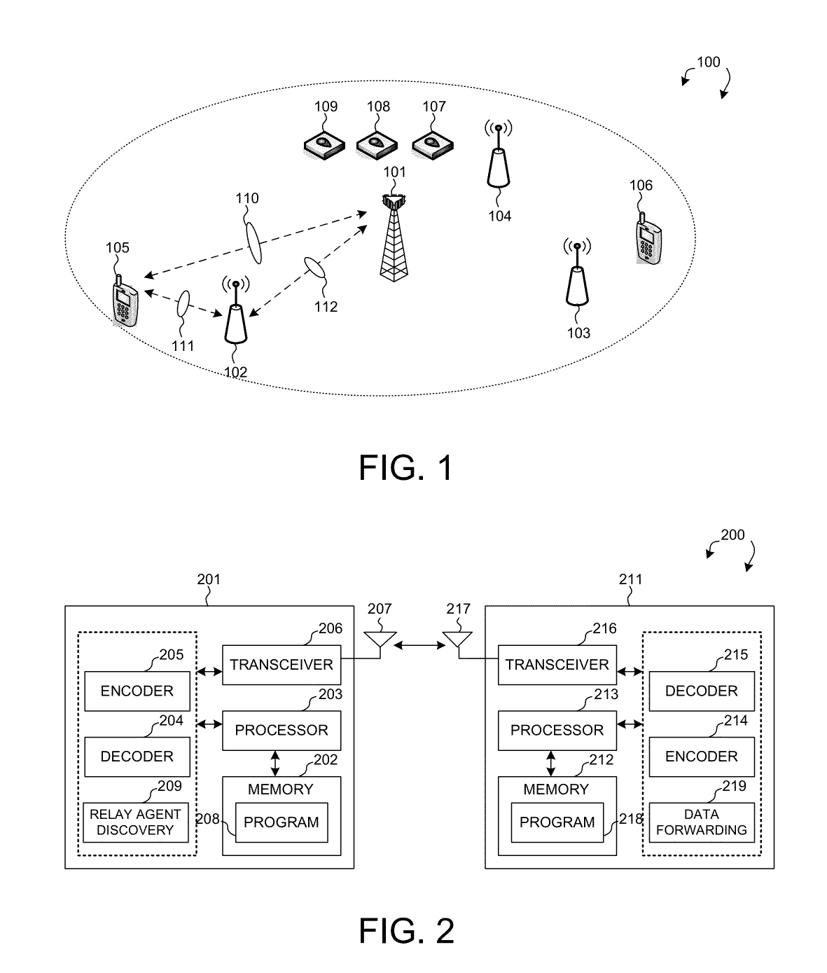

FIG. 1 illustrates a wireless communications network 100 with distributed relay agents in accordance with a novel aspect. Wireless communications network 100 comprises an access point AP 101, a plurality of relay agents RA 102-104, and a plurality of wireless stations STA 105-109. Typically, a wireless station can establish a wireless link with an access point via passive scanning or active scanning. Take STA 105 as an example, for passive scanning, STA 105 receives Beacon frames from AP 101. In response, STA 105 sends an Association Request frame to AP 101, and receives an Association Response frame from AP 101. After association and authentication, a wireless link 110 is established between STA 105 and AP 101. On the other hand, for active scanning, STA 105 broadcasts a Probe Request frame and receives a Probe Response frame from AP 101 in response. Next, STA 105 sends an Association Request frame to AP 101, and receives an Association Response frame from AP 101 in response. After association and authentication, wireless link 110 is then established between STA 105 and AP 101.

If a wireless station has limited range extension, or if a wireless station is battery-operated and wants to conserve power, then such station can extend the range of its transmission and achieve power saving via a nearby relay agent. For example, STA 105 can extend its transmission range and save power consumption by using nearby relay agent RA 102. That is, STA transmits its data with low power to relay agent RA 102 (e.g., via wireless link 111), which forwards the data to AP 101 (e.g., via wireless link 112). Conventionally, the relay agents RA 102-104 are pre-configured statically by the administrator of wireless network 100. Such static configuration, however, cannot accommodate the mobility requirements of the wireless communications network. First, wireless communications devices are not necessarily distributed uniformly in the coverage area of wireless communications network 100, the loading of relay agents differ and it is hard to re-distribute the loading under static setup. Second, wireless stations STA 105-109 are moving and a previous association between a wireless station and a relay agent may no longer be suitable. For example, when STA 105 moves from its previously location to another location near STA 106, STA 105 may want to terminate its association with relay agent RA 102 and want to associate with relay agent RA 103 for data forwarding.

In one novel aspect, a wireless station (e.g., STA 105) initiates a relay agent discovering process by soliciting a specific relay agent or broadcasting a request to all candidate relay agents. The wireless station initiates the process of relay agent discovery in accordance with a pre-determined rule. For example, STA 105 may use smaller power to find a closest relay agent, or carry a special request to find a relay agent that can accommodate the special request. Furthermore, in the opportunistic relay agent discovery, it is up to the relay agent (e.g., relay agent RA 102) to decide whether it would like to relay data traffic for a wireless station (e.g., STA 105) in accordance with a pre-determined rule. For example, relay agent RA 102 may make decisions based on its channel and system loading and the channel characteristics between relay agent RA 102 and STA 105.

FIG. 2 is a simplified block diagram of a wireless station 201 and a wireless relay agent 211 in accordance with a novel aspect. For wireless device 201, antenna 207 transmits and receives radio signals. RF transceiver module 206, coupled with the antenna, receives RF signals from the antenna, converts them to baseband signals and sends them to processor 203. RF transceiver 206 also converts received baseband signals from the processor, converts them to RF signals, and sends out to antenna 207. Processor 303 processes the received baseband signals and invokes different functional modules to perform features in wireless device 201. Memory 202 stores program instructions and data 208 to control the operations of the wireless device.

Similar configuration exists in wireless device 211 where antenna 217 transmits and receives RF signals. RF transceiver module 216, coupled with the antenna, receives RF signals from the antennae, converts them to baseband signals and sends them to processor 213. The RF transceiver 216 also converts received baseband signals from the processor, converts them to RF signals, and sends out to antenna 217. Processor 213 processes the received baseband signals and invokes different functional modules to perform features in wireless device 211. Memory 212 stores program instructions and data 218 to control the operations of the wireless device.

The wireless devices 201 and 211 also include several functional modules to perform certain embodiments of the present invention. In the example of FIG. 2, wireless device 201 is a wireless communications station that includes an encoder 205, a decoder 206, and a relay agent discovery module 209 for initiating relay agent discovery process. Wireless device 211 is a wireless relay agent that includes an encoder 215, a decoder 214, and a data-forwarding module 219 for performing relaying / data forwarding for wireless stations. The different functional modules can be implemented by software, firmware, hardware, or any combination thereof. The function modules, when executed by the processors 203 and 213 (e.g., via executing program codes 208 and 218), allow wireless station 201 and wireless relay agent 211 to perform certain embodiments of the present invention.

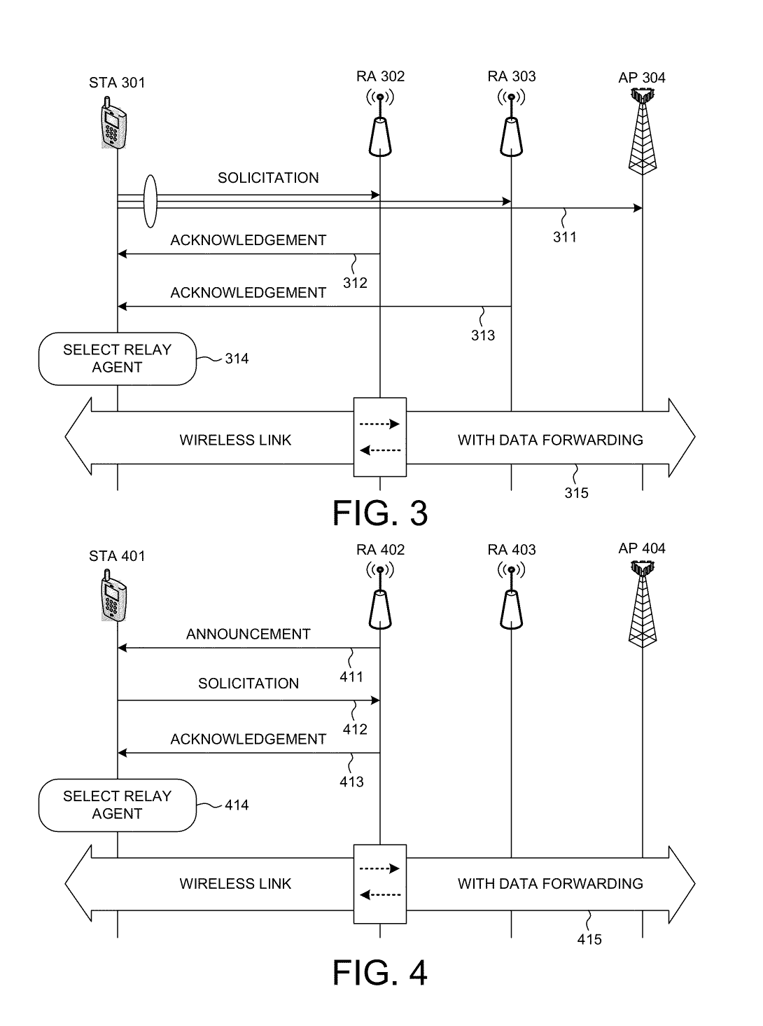

FIG. 3 is a diagram of a method of relay agent discovery with active scanning in a wireless network 300. Wireless network 300 comprises STA 301, candidate relay agents RA 302-303, and AP 304. In step 311, STA 301 broadcasts a relay solicitation frame to all the candidate relay agents in wireless network 300. In one embodiment, the relay solicitation frame is a modified management frame such as a Probe Request frame or a new Relay Query frame (RQF). In step 312, RA 302 sends an acknowledgment frame back to STA 301 in response to the solicitation. In step 313, RA 303 also sends an acknowledgment frame back to STA 301 in response to the solicitation. In one embodiment, the acknowledgment frame is a modified management frame such as a Probe Response frame. In step 314, STA 301 determines a relay agent and selects RA 302 to be its relay agent for data forwarding. When STA 301 receives more than one relay acknowledgment frames from more than one candidate relay agents, STA 301 selects a designated relay agent (e.g., RA 302) based on its requirements. Finally, in step 315, a wireless link is established between STA 301 and RA 302, which performs data forwarding between STA 301 and AP 304. The establishing of the wireless link may involve association and authentication functionalities. In the example of FIG. 3, STA 301 initiates the relay discovery process via active scanning, e.g., broadcasting the relay solicitation frame to all candidate relay agents in the network.

FIG. 4 is a diagram of a method of relay agent discovery with passive scanning in a wireless network 400. Wireless network 400 comprises STA 401, candidate relay agents RA 402-403, and AP 404. In step 411, STA 401 receives a relay announcement frame transmitted by RA 402. The relay announcement frame indicates that RA 402 is capable and willing to become a relay agent for other wireless devices. In one embodiment, the relay announcement frame is a Beacon frame. In step 412, STA 401 unicasts a relay solicitation frame to RA 402 in response to the received relay announcement frame. In step 413, RA 402 sends an acknowledgment frame back to STA 401 in response to the solicitation. In step 414, STA 401 selects RA 402 to become its relay agent for data forwarding. Finally, in step 415, a wireless link is established between STA 401 and RA 402, which performs data forwarding between STA 401 and AP 404. In the example of FIG. 4, STA 401 initiates the relay discovery process via passive scanning, e.g., unicasting the relay solicitation frame to a specific relay agent in response to received relay announcement frame.

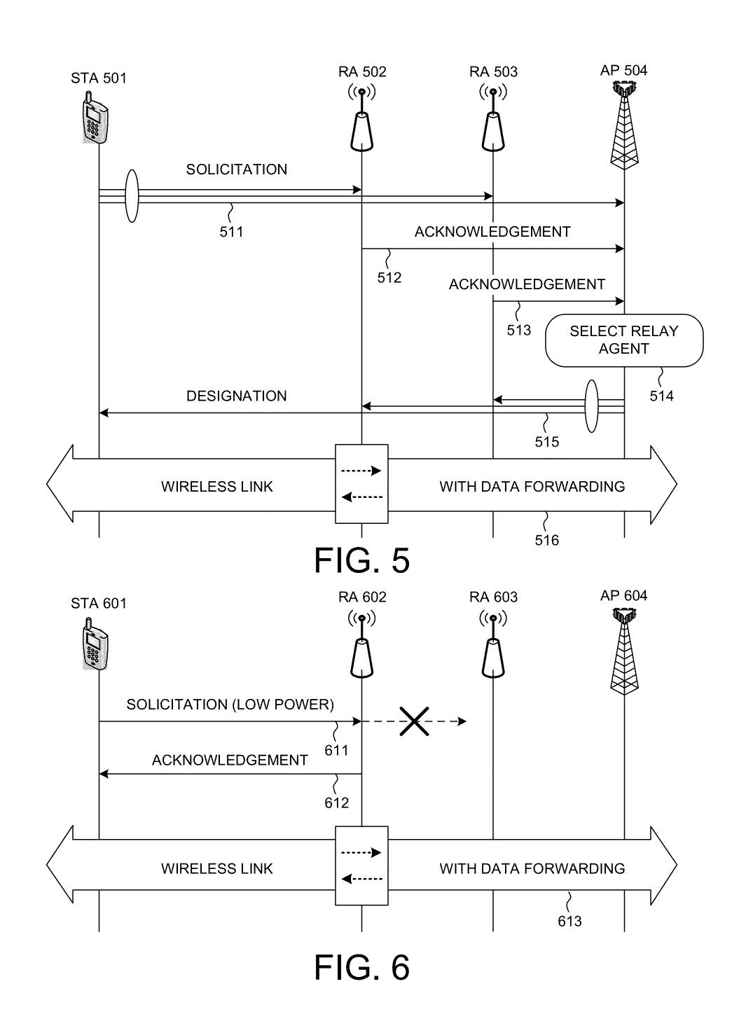

FIG. 5 illustrates one embodiment of designating relay agent via an access point in a wireless network 500. Wireless network 500 comprises STA 501, candidate relay agents RA 502-503, and AP 504. In step 511, STA 501 broadcasts a relay solicitation frame to all the candidate relay agents in wireless network 500, including to AP 504. In step 512, RA 502 sends a relay acknowledgment frame to AP 504 in response to the solicitation. In step 513, RA 503 also sends a relay acknowledgment frame to AP 504 in response to the solicitation. In one embodiment, the relay acknowledgment frame is a Relay Nomination frame (RNF). The RNF carries AID of STA 501 that sends the relay solicitation frame. The RNF may carry additional link quality information, such as the signal-to-noise ratio (SNR) or a channel measurement report. For example, the RNF sent by relay agent RA 502 includes loading of RA 502, and channel characteristics between RA 502 and STA 501 that sends the relay solicitation frame.

In step 514, AP 504 determines the best relay agent for STA 501 (and all other wireless stations that solicit for relay agents in the network) based on received relay acknowledgment frames from all candidate relay agents. After AP 504 selects the best relay agent for each soliciting station (e.g., RA 502 is the best relay agent for STA 501), in step 515, AP 504 broadcasts a Relay Designation frame (RDF) to all wireless devices in the network. All the wireless stations and candidate relay agents in wireless network 500 learn about the designated relay of each soliciting STA via the RDF. For example, the soliciting station STA 501 learns the AID and/or the MAC address of its designated relay agent RA 502 via the RDF. Finally, in step 516, a wireless link is established between STA 501 and RA 502, which performs data forwarding between STA 501 and AP 504.

FIG. 6 illustrates one embodiment of determining relay agent from wireless station perspective in wireless network 600. Wireless network comprises STA 601, candidate relay agents RA 602-603, and AP 604. In step 611, STA 601 sends (e.g., either broadcasts or unicasts) a relay solicitation frame to RA 602. In one embodiment, the relay solicitation frame is sent based on a predetermined rule. For example, the relay solicitation frame is sent using a low transmit power. The relay solicitation frame cannot reach relay agents that are located far away because of its low transmit power. STA 601 can gradually increase the transmitting power until a nearby relay agent is found. For example, the transmit power of the relay solicitation frame is high enough to reach a nearby RA 602, but not high enough to reach a remote RA 603. This way, STA 601 is able to save power consumption even during the relay discovery process and find the closest relay agent with minimum power. In another embodiment, the relay solicitation frame comprises a special request so that STA 601 is able to find a relay agent that can accommodate the special request. For example, STA 601 may specifically search for a relay agent able to support isochronous streaming operation. In one example, the relay solicitation frame may include link budget information and additional QoS requirements for the relay path. In step 612, RA 602 transmits a relay acknowledgment frame back to STA 601 in response to the solicitation. In step 613, a wireless link is established between STA 601 and RA 602, which performs data forwarding between STA 601 and AP 604.

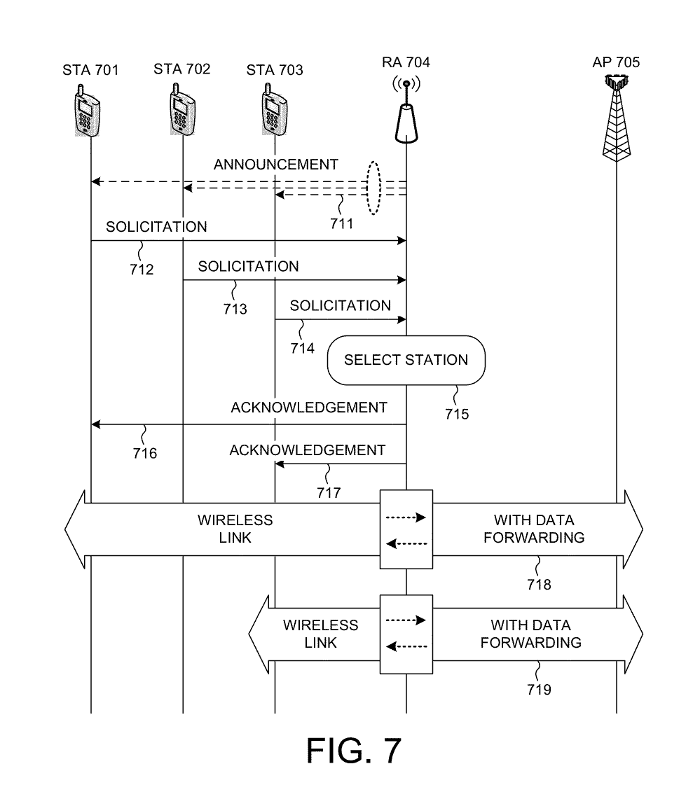

FIG. 7 illustrates one embodiment of determining relay agent from relay agent perspective in wireless network 700. Wireless network 700 comprises a plurality of STAs 701-703, a candidate relay agent RA 704, and AP 705. In step 711, relay agent RA 704 broadcasts a relay announcement frame to all wireless devices in the network. The relay announcement frame may be a Beacon frame that indicates RA 704 is capable and willing to be a relay agent for other wireless devices in the network. In step 712, STA 701 sends a relay solicitation frame to RA 704. In step 713, STA 702 sends a relay solicitation frame to RA 704. In step 714, STA 703 sends a relay solicitation frame to RA 704. In step 715, RA 704 determines whether it would like to be the relay agent for soliciting STAs 701-703. For example, RA 704 make such determination based on the loading of RA 704, or based on the channel characteristics between RA 704 and each STA. In addition, RA 704 could make such determination based on whether RA 704 can accommodate the additional link requirements specified in each relay solicitation frame by each STA. After such determination, RA 704 responds to STA 701 with a relay acknowledgement frame (step 716), and responds to STA 703 with a relay acknowledgment frame (step 717). However, RA 704 does not send any relay acknowledgment frame to STA 702 due to considerations such as loading and channel condition. As a result, RA 704 does not become a relay agent for STA 702. Finally, a wireless link is established between STA 701 and RA 704 (step 718) and between STA 703 and RA 704 (step 719). Consequently, RA 704 performs data forwarding between STA 701 and AP 705, and between STA 703 and AP 705.

In one embodiment, after successful relay agent designation, the soliciting STA may start to use the relay agent for its uplink traffic. For example, the STA sends a data frame to its relay agent with a relay bit set. If the relay agent relays the data frame, it ACKs to the STA the reception of the data frame. Otherwise it does not ACK the data frame. The relay agent then forwards the data frame to the AP as a relayed frame by checking the relay bit. The AP receives the relayed frame from the relay agent and ACKs to the relay agent the relayed frame. In another embodiment, to terminate the relay gracefully, the STA sends a Relay Termination frame (RTF) to the relay agent. In response, the relay agent forwards the RTF to the AP. The AP broadcasts an RDF containing null-designation for the AID to confirm the reception of the RTF and the relay is then terminated.

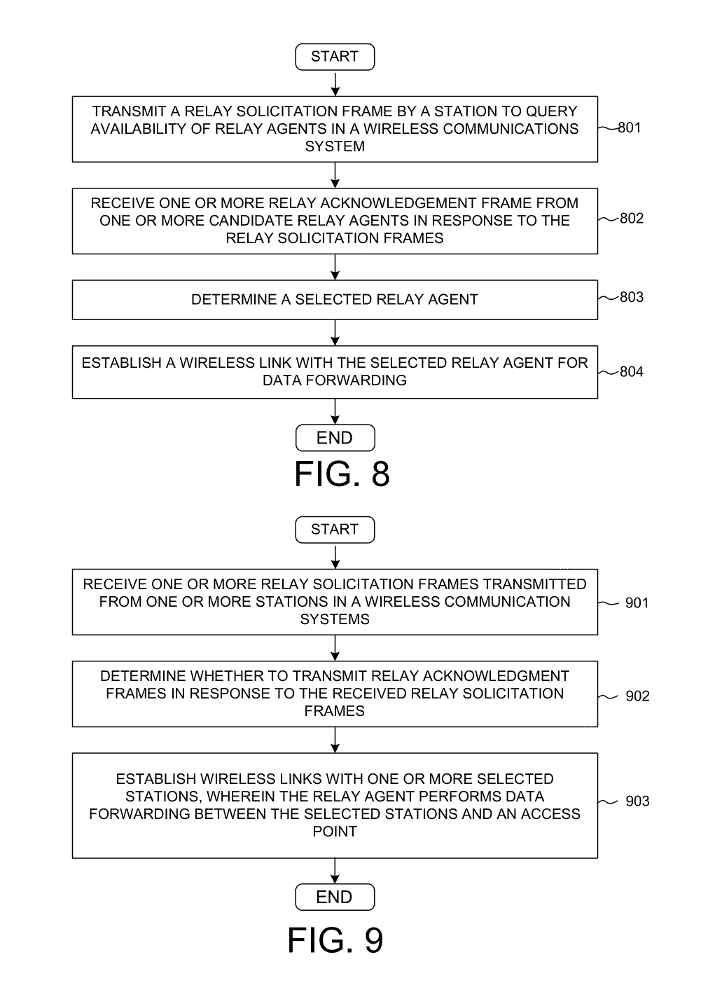

FIG. 8 is flow chart of a method of discovering relay agent from wireless station perspective in accordance with a novel aspect. In step 801, a wireless station transmits a relay solicitation frame to query availability of relay agents in a wireless communications system. In one example, the relay solicitation frame is broadcasted to all candidate relay agents in the wireless system. In another example, the relay solicitation frame is unicasted to a specific relay agent in response to a relay announcement frame from the specific relay agent. In another example, the relay solicitation frame is transmitted according to a specific transmit power or a specific modulation and coding scheme. In yet another example, the relay solicitation frame contains additional link requirement information. In step 802, the wireless station receives one or more relay acknowledgment frames from one or more candidate relay agents in response to the relay solicitation frames. In step 803, the wireless station determines a selected relay agent. In one example, the selected relay agent is determined based on loading of the selected relay agent and channel characteristics between the station and the selected relay agent. In step 804, the wireless station establishes a wireless link with the selected relay agent for data forwarding between the wireless station and a wireless access point of the wireless system.

FIG. 9 is a flow chart of a method of discovering relay agent from relay agent perspective in accordance with a novel aspect. In step 901, a relay agent receives one or more relay solicitation frames transmitted from one or more wireless stations in a wireless communications system. In one example, the relay agent first transmits an announcement frame such as a Beacon frame to announce an intent to become the relay agent before receiving the relay solicitation frames. In step 902, the relay agent determines whether to transmit relay acknowledgement frames in response to the received relay solicitation frames. In one example, the relay agent determines whether to respond to the relay solicitation frames based on loading of the relay agent and channel characteristics between the stations and the relay agent. In another example, the relay acknowledgment frames comprise additional link quality information corresponds to the relay agent. In step 903, the relay agent establishes wireless links with one or more selected stations, and the relay agent performs data forwarding between the selected stations and an access point of the wireless system.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
transmitting a relay solicitation frame by a station to query availability of relay agents in a wireless communications system;
receiving one or more relay acknowledgement frames from one or more candidate relay agents in response to the relay solicitation frames;
determining a selected relay agent; and
establishing a wireless link with the selected relay agent, wherein the selected relay agent performs data forwarding between the station and an access point.

2. The method of claim 1, wherein the relay solicitation frame is a probe request frame, and wherein the acknowledgement frame is a probe response frame.

3. The method of claim 1, wherein the relay solicitation frame is broadcasted to all candidate relay agents in the wireless communications system.

4. The method of claim 1, further comprising:
receiving a relay announcement frame transmitted by a relay agent, wherein the solicitation frame is unicasted to the relay agent.

5. The method of claim 1, wherein the relay solicitation frame is transmitted according to a specific transmit power or a specific modulation and coding scheme.

6. The method of claim 1, wherein the relay solicitation frame comprises additional link requirement information for the wireless link.

7. The method of claim 1, wherein the relay acknowledgment frame comprises additional link quality information corresponds to the candidate relay agent.

8. The method of claim 1, wherein the selected relay agent is determined based on loading of the selected relay agent and channel characteristics between the station and the selected relay agent.

9. A method, comprising:
receiving, by a relay agent, one or more relay solicitation frames transmitted from one or more stations in a wireless communications system;
determining whether to transmit corresponding relay acknowledgment frames in response to the received relay solicitation frames; and
establishing wireless links with one or more selected stations, wherein the relay agent performs data forwarding between the selected stations and an access point.

10. The method of claim 9, wherein one of the relay solicitation frames is a probe request frame, and wherein one of the relay acknowledgement frame is a probe response frame.

11. The method of claim 9, wherein the relay solicitation frames are broadcasted by the stations to all candidate relay agents in the wireless communications system.

12. The method of claim 9, further comprising:
transmitting an announcement frame to announce an intent to become the relay agent, wherein the relay solicitation frames are unicasted to the relay agent.

13. The method of claim 9, wherein the relay solicitation frames comprise additional link requirement information for the wireless link.

14. The method of claim 9, wherein the relay acknowledgment frames comprise additional link quality information corresponds to the relay agent.

15. The method of claim 9, wherein the relay agent determines whether to respond to the relay solicitation frames based on loading of the relay agent and channel characteristics between the stations and the relay agent.

16. A method, comprising:
transmitting a relay solicitation frame by a station to query availability of relay agents in a wireless communications system;
receiving a relay designation frame from an access point in response to the relay solicitation frames; and
establishing a wireless link with a designated relay agent, wherein the designated relay agent performs data forwarding between the station and the access point.

17. The method of claim 16, wherein the relay solicitation frame is broadcasted by the station to all candidate relay agents in the wireless communications system.

18. The method of claim 16, wherein the relay solicitation frame is transmitted according to a specific transmit power.

19. The method of claim 16, wherein the relay solicitation frame contains additional criteria in order to find the best relay agent.
